(19) United States
(12) Patent Application Publication
(10) Pub. No.: US 2014/0255768 A1
(43) Pub. Date: Sep. 11, 2014

(54) ULTRASONIC HORN AND SECONDARY BATTERY MANUFACTURED USING THE SAME

(71) Applicants: ROBERT BOSCH GMBH, Stuttgart (DE); SAMSUNG SDI CO., LTD., Yongin-si (KR)

(72) Inventor: Sung-Hwan JANG, Yongin-si (KR)

(73) Assignees: ROBERT BOSCH GMBH, Stuttgart (DE); SAMSUNG SDI CO., LTD., Yongin-si (KR)

(21) Appl. No.: 14/103,886

(22) Filed: Dec. 12, 2013

(30) Foreign Application Priority Data
Mar. 7, 2013 (KR) 10-2013-0024542

(51) Int. Cl. H01M 2/26; B23K 20/10

(52) U.S. Cl. CPC H01M 2/26; B23K 20/106
USPC 429/179; 429/211; 228/1.1; 429/163

(57) ABSTRACT

An ultrasonic horn and a secondary battery manufactured using the ultrasonic horn are disclosed. The ultrasonic horn has a pressing surface at an end thereof, the ultrasonic horn including a protrusion part disposed on the pressing surface, the protrusion part including a first protrusion row that includes a plurality of protrusions consecutively arranged along a first direction, and a second protrusion row that includes a plurality of protrusions consecutively arranged along the first direction and is separated from the first protrusion row by a predetermined distance in a second direction that is different from the first direction.

### CROSS-REFERENCE TO RELATED APPLICATION

Korean Patent Application No. 10-2013-0024542, filed on Mar. 7, 2013, in the Korean Intellectual Property Office, and entitled: “ULTRASONIC HORN AND SECONDARY BATTERY MANUFACTURED USING THE SAME,” is incorporated by reference herein in its entirety.

### BACKGROUND

1. Field

Embodiments relate to an ultrasonic horn and a secondary battery manufactured using the same.

2. Description of the Related Art

Secondary batteries can be repeatedly charged and discharged. Secondary batteries are used as an energy source for mobile devices, electric cars, hybrid cars, electric bicycles, uninterruptible power supplies (UPS), and the like. A secondary battery may be a single battery or a battery module including a plurality of batteries electrically connected using a bus bar.

### SUMMARY

Embodiments are directed to an ultrasonic horn having a pressing surface at an end thereof, the ultrasonic horn including a protrusion part disposed on the pressing surface, the protrusion part including a first protrusion row that includes a plurality of protrusions consecutively arranged along a first direction, and a second protrusion row that includes a plurality of protrusions consecutively arranged along the first direction and is separated from the first protrusion row by a predetermined distance in a second direction that is different from the first direction.

The plurality of protrusions in the first and second protrusion rows may have a conical or pyramid shape.

The plurality of protrusions in the first protrusion row may have a different vertex angle from the plurality of protrusions in the second protrusion row.

The plurality of protrusions in the first protrusion row may have a same height as that of the plurality of protrusions in the second protrusion row.

The predetermined distance may be about 0.8 mm to about 1.5 mm.

The predetermined distance may be about 0.8 h to about 1.5 h, where h is a height of the plurality of protrusions.

The first and second protrusion rows may be repeatedly arranged along the second direction.

Embodiments are also directed to a secondary battery including electrode tabs and an electrode assembly ultrasonically welded to each other by using the ultrasonic horn according to an embodiment.

Embodiments are also directed to a secondary battery, including an electrode assembly, an electrode tab ultrasonically welded to the electrode assembly and having a groove pattern part on one surface, and a case accommodating the electrode assembly and the electrode tab. The groove pattern part may include a first groove portion and a second groove portion, each groove portion including a plurality of grooves arranged along a first direction. The second groove portion may be separated from the first groove portion by a predetermined distance in a second direction that is different from the first direction, and an interval between adjacent grooves of the plurality of grooves in the first and second groove portions may be less than the predetermined distance.

The plurality of grooves in the first and second groove portions may have a conical or pyramid shape with a vertex pointing downward.

The plurality of grooves in the first groove portion may have a different vertex angle than that of the plurality of grooves in the second groove portion.

The plurality of grooves in the first groove portion may have a same depth as that of the plurality of grooves in the second groove portion.

The predetermined distance may be about 0.8 mm to about 1.5 mm.

The predetermined distance may be about 0.8 d to about 1.5 d, where d is a depth of the plurality of grooves.

The first and second groove portions may be repeatedly arranged along the second direction.

The secondary battery may further include a cap plate that closes the case and has a terminal insertion hole longitudinally penetrating the cap plate, a terminal including a terminal plate exposed out of the case and a connecting portion that passes through the terminal insertion hole and connects the electrode tab with the terminal plate, and a fixing member that fixes the terminal to the cap plate.

The fixing member may have a plastic mold structure formed by injection molding a plastic resin into the terminal insertion hole when the connecting portion is inserted into the terminal insertion hole.

The fixing member may include a first fixing portion for filling the terminal insertion hole and a second fixing portion for filling a gap between the terminal plate and a top surface of the cap plate.

The fixing member may include an insulating gasket interposed between the connecting portion and the cap plate so as to fill a gap between the connecting portion and the terminal insertion hole.

The insulating gasket may include an upper gasket adapted to be inserted into the terminal insertion hole from a top surface of the cap plate and a lower gasket adapted to be inserted into the terminal insertion hole from a bottom surface of the cap plate.

### BRIEF DESCRIPTION OF THE DRAWINGS

Features will become apparent to those of skill in the art by describing in detail example embodiments with reference to the attached drawings in which:

FIG. 1 illustrates a schematic diagram of an ultrasonic horn according to an example embodiment;

FIG. 2 illustrates a schematic diagram of an ultrasonic horn according to another example embodiment;

FIG. 3 illustrates a schematic diagram of an ultrasonic horn according to another example embodiment;

FIG. 4 illustrates an exploded perspective view of a secondary battery according to an example embodiment;

FIG. 5 illustrates a cross-sectional view taken along a line X-X′ of FIG. 4;

FIG. 6 illustrates a perspective view showing an example of an electrode assembly used in the secondary battery of FIG. 4;

FIG. 7A illustrates a perspective view of a stage in a process by which electrode tabs are joined to an electrode assembly according to an example embodiment;

FIG. 7B illustrates a partial enlarged view showing an operation of using an ultrasonic horn in the process illustrated in FIG. 7A;

FIG. 8A illustrates a plan view showing a shape of a groove pattern part formed in an electrode tab according to an ultrasonic welding process according to an example embodiment, and FIGS. 8B and 8C are cross-sectional views taken along lines B-B′ and C-C′ of FIG. 8A;

FIG. 9 illustrates a schematic cross-sectional view of a secondary battery according to another example embodiment; and

FIG. 10 illustrates a schematic cross-sectional view of a secondary battery according to another example embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. In the drawing figures, the dimensions of layers and regions may be exaggerated for clarity of illustration. Like reference numerals refer to like elements throughout.

It will be understood that when an element is referred to as being “on” or “over” another element, it can be directly on the other element or intervening elements may also be present. Expressions such as “at least one of,” when preceding a list of elements, modify the entire list of elements and do not modify the individual elements of the list.

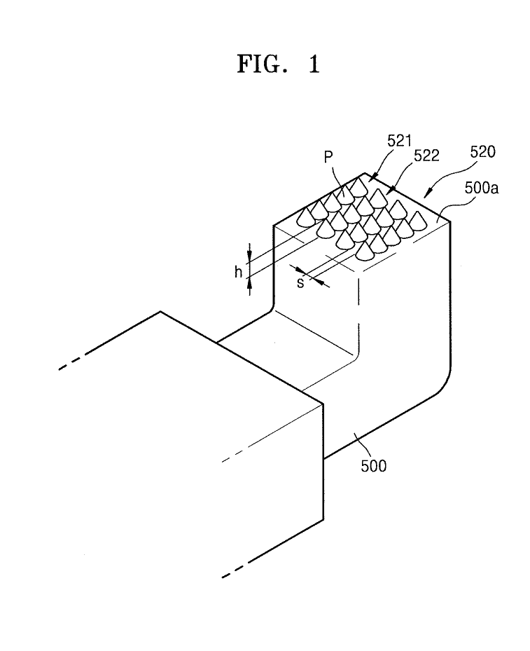

FIG. 1 illustrates a schematic diagram of an ultrasonic horn 500 according to an example embodiment.

An ultrasonic welding process includes transmitting a vibration energy of ultrasonic wave to a welding object and joining welding objects to each other by using heat generated by the vibration energy.

According to the present example embodiment, the ultrasonic horn includes a pressing surface 500a for pressing a welding object, and a protrusion part 520 that is disposed on the pressing surface 500a. The protrusion part 520 may efficiently transmit the vibration energy.

According to the present example embodiment, the protrusion part 520 includes first and second protrusion rows 521 and 522, each protrusion row including a plurality of protrusions P consecutively arranged along a first direction. The second protrusion row 522 is separated from the first protrusion row 521 by a predetermined distance s in a second direction that is different from the first direction.

The plurality of protrusions P in the first and second protrusion rows 521 and 522 may be consecutively arranged without a space therebetween, e.g., such that bases of the protrusions P within the respective rows are in contact with one another along the first direction, while the first protrusion row 521 is spaced from the second protrusion row 522 by the predetermined distance s. The protrusion part 520 may be arranged in such a way as to efficiently disperse a tensile strength to welding objects by appropriately determining the distance s between the first and second protrusion rows 521 and 522. The distance s may be, e.g., about 0.8 mm to about 1.5 mm. When a height of each protrusion P is denoted by h, the distance s may be, e.g., about 0.8 h to about 1.5 h.

In the example embodiment shown in FIG. 1, the plurality of protrusions P in the first and second protrusion rows 521 and 522 may have a conical shape. In other example embodiments, the protrusions P in the first and second protrusion rows 521 and 522 may have other shapes, the first and second protrusion rows 521 and 522 may be arranged in a repeated alternating fashion, etc.

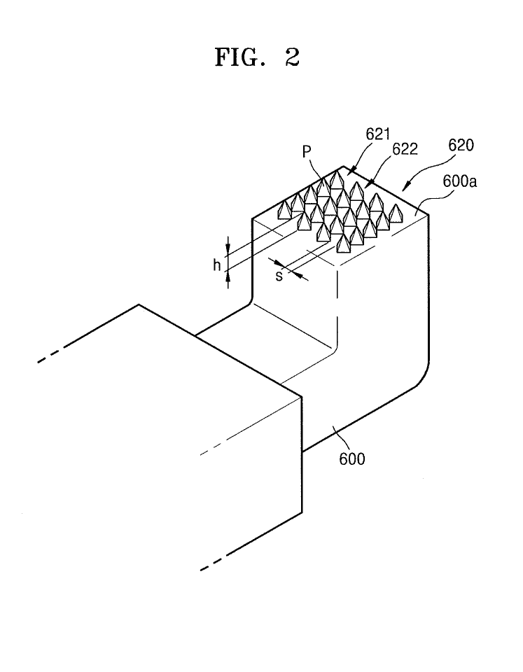

FIG. 2 illustrates a schematic diagram of an ultrasonic horn 600 according to another example embodiment.

Referring to FIG. 2, the ultrasonic horn 600 according to the present example embodiment is different from the ultrasonic horn 500 of FIG. 1 in terms of the shape of a plurality of protrusions P in a protrusion part 620. According to the present example embodiment, the ultrasonic horn 600 includes first and second protrusion rows 621 and 622 separated from each other on a pressing surface 600a. Within the respective rows, the protrusions P may be in contact with an adjacent protrusion P. The plurality of protrusions P in the first and second protrusion rows 621 and 622 may have a pyramid or polypyramid shape, e.g., a pyramidal shape with a square or rectangular base.

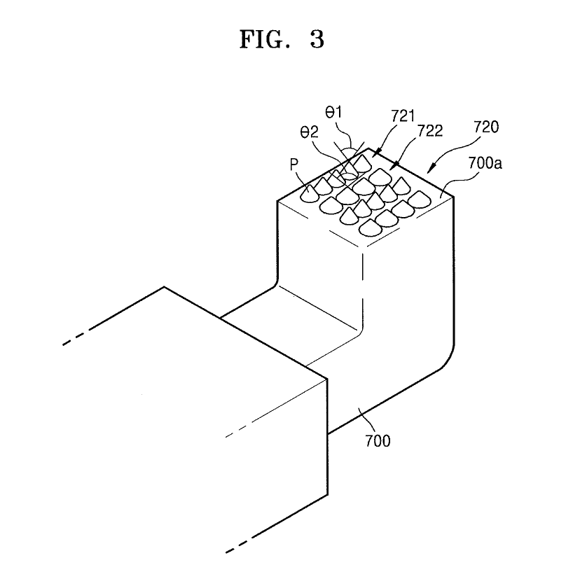

FIG. 3 illustrates a schematic diagram of an ultrasonic horn 700 according to another example embodiment.

The ultrasonic horn 700 according to the present example embodiment is different from the ultrasonic horn 500 of FIG. 1 in that a plurality of protrusions P in the first protrusion row 721 have a different vertex angle than that of a plurality of protrusions P in the second protrusion row 722. Each of the protrusions P in the first protrusion row 721 may have a vertex angle θ1 while each of the protrusions P in the second protrusion row 722 has a vertex angle θ2 that is different from θ1. In the example embodiment shown in FIG. 3, the plurality of protrusions P in the first protrusion row 721 may have the same height as, but a different vertex angle θ than, those in the second protrusion row 722. In the example embodiment shown in FIG. 3, the plurality of protrusions P have a conical shape. In other example embodiments, the plurality of protrusions P may have, e.g., a pyramid shape, the first and second protrusion rows 721 and 722 may be arranged in a repeated alternating fashion, etc.

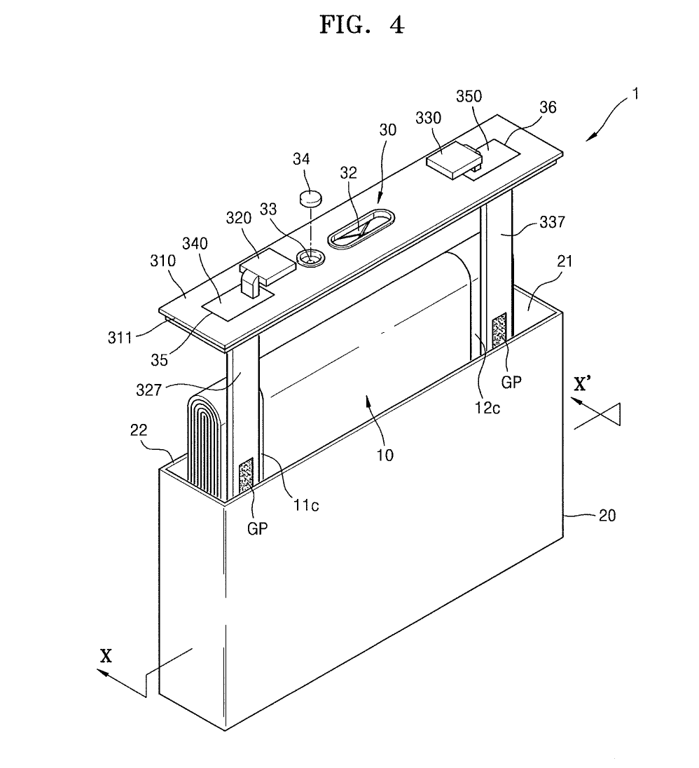

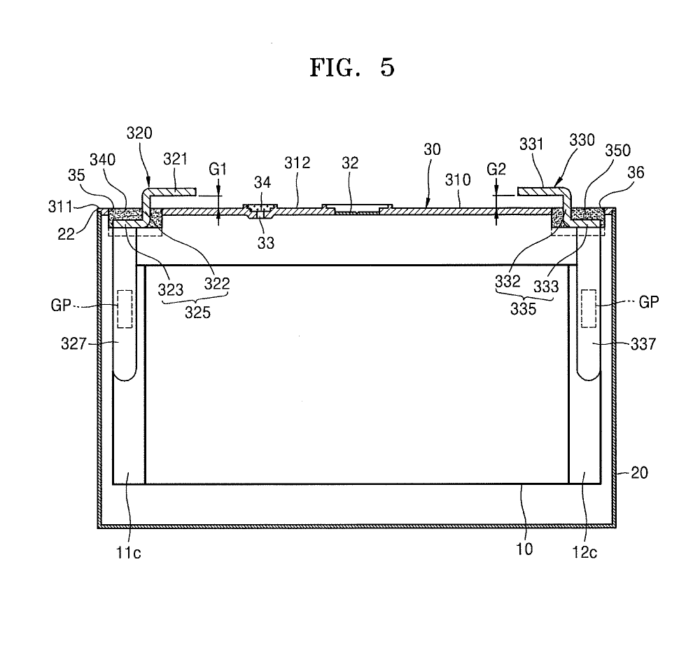

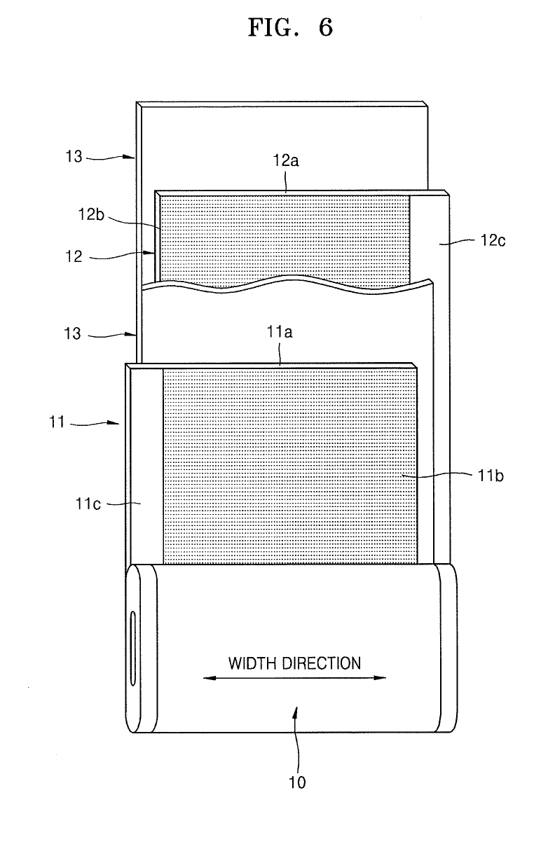

FIG. 4 illustrates an exploded perspective view of a secondary battery 1 according to an example embodiment. FIG. 5 illustrates a cross-sectional view taken along a line X-X′ of FIG. 4. FIG. 6 illustrates a perspective view showing an example of an electrode assembly 10 used in the secondary battery of FIG. 4.

According to the present example embodiment, the secondary battery 1 includes the electrode assembly 10, anode and cathode tabs 327 and 337, each having an groove pattern part GP on a surface thereof, which are joined to the electrode assembly 10 by ultrasonic welding, and a case 20 that accommodates the electrode assembly 10 and the anode and cathode tabs 327 and 337.

According to the present example embodiment, the groove pattern part GP has a pattern corresponding to a shape of the protrusion part, e.g., 520, 620, or 720, during ultrasonic welding by which the electrode assembly 10 is attached to the anode and cathode tabs 327 and 337 by using an ultrasonic horn, e.g., 500, 600, or 700, according to example embodiments. The pattern of the groove pattern part GP will be described in more detail below.

The secondary battery 1 may further include a cap plate 310 that closes the case 20 and has anode and cathode terminal insertion holes 35 and 36 longitudinally formed therein, anode and cathode terminals 320 and 330 including anode and cathode terminal plates 321 and 331 exposed out of the case 20, and having anode and cathode connecting portions 325 and 335 that respectively penetrate through the anode and cathode terminal insertion holes 35 and 36 so as to connect the anode and cathode tabs 327 and 337 with the anode and cathode terminal plates 321 and 331, respectively, and anode and cathode fixing members 340 and 350 for respectively fixing the anode and cathode terminals 320 and 330 to the cap plate 310, respectively. The cap plate 310, the anode and cathode terminals 320 and 330, the anode and cathode tabs 327 and 337, and the anode fixing member 340 and cathode fixing member 350 may be coupled to the electrode assembly 10 and may form a cap assembly 30 that seals an upper portion of the case 20.

The case 20 has an opening 21 into which the electrode assembly 10 is inserted, and the cap plate 310 is combined with the case 20 so as to close the opening 21. A rim 311 of the cap plate 310 may be mated with an upper edge 22 of the case 20. The cap plate 310 is coupled with the case 20, e.g., by laser welding, to form a housing for accommodating the electrode assembly 10.

The cap plate 30 has a safety vent 32 to provide a gas discharge path when the internal pressure of the case 20 exceeds a preset point. The cap plate 30 also has an electrolyte injection port 33 through which an electrolyte is injected into the case 20. The electrolyte injection port 33 may be sealed by a sealing cap 34 after completing the injection.

Referring to FIG. 6, the electrode assembly 10 includes an anode plate 11, a cathode plate 12, and a separator 13 interposed between the positive and cathode plates 11 and 12. For example, a stack of the anode plate 11, the cathode plate 12, and the separator 12 may be rolled in a jelly-roll shape.

According to the present example embodiment, the anode plate 11 includes an anode current collector 11a, an anode active material layer 11b formed on at least one side of the anode current collector 11a, and an anode uncoated portion 11c having no anode active material layer 11b and formed at one edge of the anode plate 11 along a width direction of the anode current collector 11a. The cathode plate 12 includes a cathode current collector 12a, a cathode active material layer 12b formed on at least one side of the cathode current collector 12a, and a cathode uncoated portion 12c having no cathode active material layer 12b and formed at one edge of the cathode plate 12 along a width direction of the cathode current collector 12a. The anode uncoated portion 11c and the cathode uncoated portion 12c may be separated from each other in a width direction of the electrode assembly 10. For example, the anode uncoated portion 11c and the cathode uncoated portion 12c may be disposed at either edge of the electrode assembly 10 in the width direction thereof.

The anode and cathode terminals 320 and 330 are electrically connected with the anode uncoated portion 11c and the cathode uncoated portion 12c of the electrode assembly 10, respectively. The anode uncoated portion 11c and the cathode uncoated portion 12c are electrically exposed out of the case 20 by the anode terminal 320 and the cathode terminal 330, respectively. The anode and cathode terminal insertion holes 35 and 36 penetrate the cap plate 310 in a longitudinal direction. The anode terminal 320 and the cathode terminal 330 are inserted into the anode and cathode terminal insertion holes 35 and 36, respectively, and fixed to the cap plate 310 by the anode fixing member 340 and the cathode fixing member 350, respectively.

The anode terminal 320 includes the anode terminal plate 321 and the anode connecting portion 325 for connecting the anode terminal plate 321 with the anode tab 327. The cathode terminal 330 includes the cathode terminal plate 331 and the cathode connecting portion 335 for connecting the cathode terminal plate 331 with the cathode tab 337. The cathode terminal plate 331 and the anode terminal plate 321 extend parallel to a top surface 312 of the cap plate 310. The anode terminal 320 and the cathode terminal 330 may be made of an electrically conductive metal. For example, the anode and cathode terminals 320 and 330 may be formed by cutting and bending a metal plate into a desired shape using press process.

The anode terminal 320 and the cathode terminal 330 may have the same shape and be arranged symmetrically to each other. Thus, only the structure of the anode terminal 320 will now be described.

The anode terminal 320 includes the anode terminal plate 321 exposed out of the case 20 and the anode connecting portion 325 that passes through the anode terminal insertion hole 35 so as to connect the anode tab 327 with the anode terminal plate 321. The anode terminal plate 321 is separated from the top surface 312 of the cap plate 310 and extends in a longitudinal direction. The anode tab 327 extends downward, i.e., in a thickness direction of the cap plate 310. The anode connecting portion 325 is bent down from the anode terminal plate 321 so as to connect the anode terminal plate 321 with the anode tab 327. The anode connecting portion 325 includes a first anode bending portion 322 that is bent and extends downward from one end of the anode terminal plate 321 and a second anode bending portion 323 that is bent and extends in a direction opposite to that in which the anode terminal plate 321 extends from one end of first anode bending portion 322. The anode tab 327 is joined to the second anode bending portion 323 so that they are electrically connected to each other.

While the anode and cathode terminals 320 and 330 have a shape as illustrated in FIG. 5, the anode (cathode) terminal 320 (330) may have various other shapes and structures including the anode (cathode) terminal plate 321 (331) exposed out of the case 20 and the anode (cathode) connecting portion 325 (335) for connecting the anode (cathode) tab 327 (337) with the anode (cathode) terminal plate 321 (331).

The anode terminal 320 and the cathode terminal 330 are inserted into the anode terminal insertion hole 35 and the cathode terminal insertion hole 36, respectively. The anode terminal plate 321 and the cathode terminal plate 331 are disposed above the cap plate 310 while the anode tab 327 and the cathode tab 337 are disposed below the cap plate 310. The anode terminal 320 and the cathode terminal 330 are then fixed to the cap plate 310 by the anode fixing member 340 and the cathode fixing member 350 that are inserted in the terminal insertion holes 35 and 36 in this state. For example, the anode and cathode fixing members 340 and 350 may be made of an electrically insulating plastic material. The anode terminal plate 321 and the cathode terminal plate 331 project upward from the cap plate 310 so as to form gaps G1 and G2 between the anode terminal 320 and the top surface 312 of the cap plate 310 and between the cathode terminal 330 and the top surface 312 of the cap plate 310. The anode terminal 320 and the cathode terminal 330 are electrically insulated from the cap plate 310 by the gaps G1 and G2 and the anode and cathode fixing members 340 and 350, respectively.

Examples of the electrically insulating plastic material may include general-purpose plastics such as polyvinyl chloride (PVC), polystyrene, high density polyethylene, and acrylonitrile butadiene styrene copolymer (ABS), general-purpose engineering plastics such as polyacetal, polyphenylene oxide (PPO), polyphenyleneether (PPE), polyamide (Pam), polycarbonate (PC), and polybutylene terephthalate (PBT), high-performance engineering plastics such as U-polymer, polysulfone (PSF), polyphenylenesulfide (PPS), polyetherimide (PEI), polyethersulfone (PES), polyarylate (PAR), polyetheretherketone (PEEK), and polytetrafluoroethylene (PTFE), and high heat-resistance plastics such as polyamideimide (PAI) and polyimide (PI). In an embodiment, the anode and cathode fixing members 340 and 350 may be formed of a resin that is a PPS added with 40% by volume of glass fibers.

The anode and cathode fixing members 340 and 350 may have a plastic mold structure. For example, the anode and cathode fixing members 340 and 350 may be formed by an insert injection molding process, e.g., by injection molding the above-described plastic resin into the anode and cathode terminal insertion holes 35 and 36, after the anode terminal 320 and the cathode terminal 330 are inserted into the anode and cathode terminal insertion holes 35 and 36, respectively.

After forming the cap assembly 30 in which the anode and cathode tabs 327 and 337 are electrically coupled to the anode and cathode terminals 320 and 330, respectively, and the anode and cathode terminals 320 and 330 are fixed to the cap plate 310 by the anode and cathode fixing members 340 and 350, respectively, the electrode assembly 10 is electrically connected to the anode tab 327 and the cathode tab 330. The anode tab 327 and the cathode tab 334 are electrically connected to the anode uncoated portion 11c and the cathode uncoated portion 12c, respectively, e.g., by ultrasonic welding.

After the cap assembly 30 is combined with the electrode assembly 10, the electrode assembly 10 is inserted into the case 20 through the opening 21, and the cap plate 310 is adhered to the case 20, e.g., by laser welding, to thereby close the opening 21. The electrode assembly 10 is electrically exposed out of the case 20 by the anode terminal 320 and the cathode terminal 330. An electrolyte is injected into the case 20 through the electrolyte injection port 33 and then the electrolyte injection port 33 is sealed by the sealing cap 34, thereby manufacturing the secondary battery 1.

In the secondary battery 1, the anode tab 327 and the cathode tab 337 may be respectively made of copper (Cu) and aluminum (Al), exhibiting different electrochemical properties. On the other hand, the anode terminal 320 and the cathode terminal 330 may be made of one of Cu and Al, identically. Thus, a heterogeneous metallic bonding may be formed between either of the anode tab 327 and the cathode tab 337 and either of the anode terminal 320 and the cathode terminal 330. Friction Stir Welding (FSW) may be considered instead of laser welding for joining heterogeneous metals. FSW may provide a sufficient welding strength between heterogeneous metals having poor weldability.

In another implementation, in the secondary battery 1, the anode tab 327 and the cathode tab 337 may be formed integrally with the anode terminal 320 and the cathode terminal 330, respectively, by using a single metal plate. Thus, the anode tab 327, the anode connecting portion 325, and the anode terminal plate 321 may be made of the same metal. The cathode tab 337, the cathode connecting portion 335, and the cathode terminal plate 331 may be made of the same metal. This may eliminate the need for a coupling process by welding, thereby reducing manufacturing costs and maintaining uniform electrical properties of current paths from the anode tab 327 to the anode terminal plate 321 and from the cathode tab 337 to the cathode terminal plate 331.

According to the present example embodiment, in the secondary battery 1, the anode terminal 320 and the cathode terminal 330 are coupled to the cap plate 310 using an insert injection molding process in which plastic resin is injected, which may provide both coupling and electrical insulation between the cap plate 310 and the anode and cathode terminals 320 and 330.

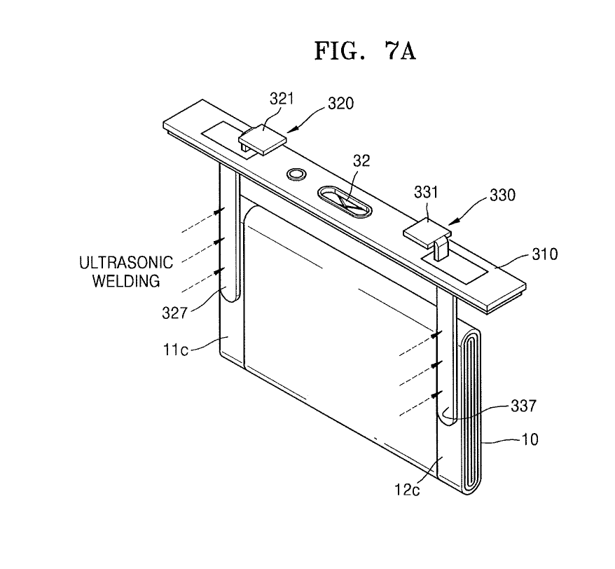

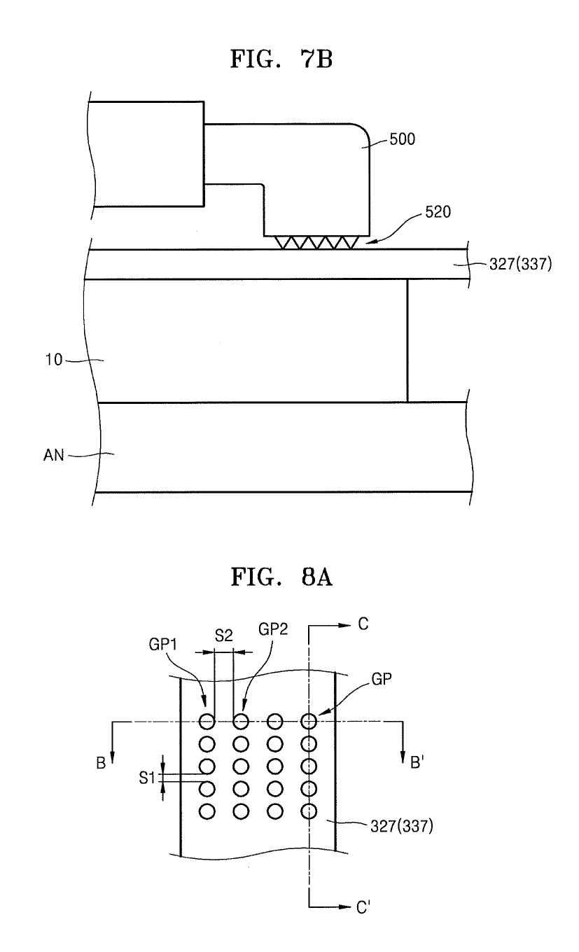

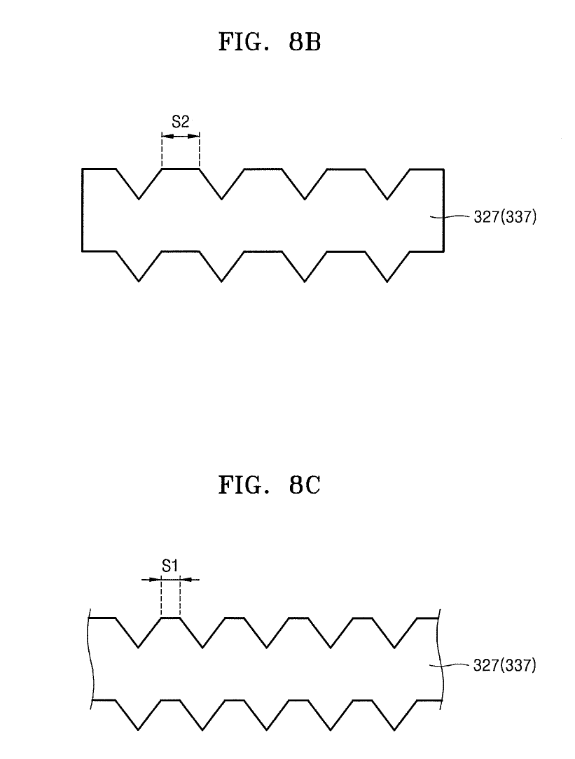

FIG. 7A illustrates a perspective view of a stage in a process by which anode and cathode tabs 327 and 337 are joined to an electrode assembly 10 according to an example embodiment. FIG. 7B illustrates a partial enlarged view showing an operation of using an ultrasonic horn 500 in the process illustrated in FIG. 7A. FIG. 8A illustrates a plan view showing a shape of an groove pattern part GP formed in the anode and cathode tabs 327 and 337 according to an ultrasonic welding process according to an example embodiment, and FIGS. 8B and 8C are cross-sectional views taken along lines B-B′ and C-C′ of FIG. 8A.

The anode tab 327 and the cathode tab 337a may be joined to the electrode assembly 10, i.e., an anode uncoated portion 11c and a cathode uncoated portion 12c, respectively, by using ultrasonic welding.

Ultrasonic welding between metal components may be implemented as a high-productivity welding method that provides high weld quality. Ultrasonic welding may use a small amount of energy and provide a short welding time, may eliminate the use of expendable welding components such as lead or flux, and may reduce environmental contamination. Ultrasonic welding may also allow welding between different materials, may reduce or eliminate brittleness failure due to melting of a material used for welding by limiting heat generated at a welded portion, and may provide higher weld strength than soldering or resistance welding along with high electrical conductivity.

According to the present example embodiment, as illustrated in FIG. 7B, ultrasonic welding includes sandwiching the anode and cathode tabs 327 and 337 and the electrode assembly 10 to be welded between an anvil AN and the ultrasonic horn 500, and applying an ultrasonic frequency vibration and a pressure through the ultrasonic horn 500 to the anode and cathode tabs 327 and 337 and the electrode assembly 10. The present example embodiment may provide frictional heat generated between the anode and cathode tabs 327 and 337 to melt the interface therebetween, and the interface may be hardened again to create a bond between the anode and cathode tabs 327 and 337 and the electrode assembly 10.

The ultrasonic horn 500 may have various shapes, e.g., the shapes illustrated in FIGS. 1 through 3, and may have shapes formed by combining or changing the shapes illustrated in FIGS. 1 through 3.

According to the present example embodiment, after the ultrasonic welding, a surface of the anode (cathode) tab 327 (337) that contacts the ultrasonic horn 500 has a groove pattern part GP corresponding to a protrusion part 520 formed in the ultrasonic horn 500. A surface opposite the surface on which the groove pattern part GP is disposed, i.e., a surface forming an interface with the electrode assembly 10, may have a protrusion pattern corresponding to the shape of groove pattern part GP, and the anode (cathode) tab 327 (337) may be joined to the electrode assembly 10.

The groove pattern part GP may not have completely the same shape as the protrusion part 520. As illustrated in FIG. 8B, the groove pattern part GP includes first and second groove portions GP1 and GP2, each groove portion including a plurality of grooves arranged along a first direction. The second groove portion GP2 is separated from the first groove portion GP1 by a predetermined distance S2 in a second direction that is different from the first direction. An interval S1 between two adjacent grooves of the plurality of grooves in the first and second groove portions GP1 and GP2 may be less than the predetermined distance S2. Unlike in the protrusion part 520 in the ultrasonic horn 500, the interval S1 may have a value greater than 0, or, similar to the arrangement of the protrusions in the protrusion part 520, the interval S1 may be equal to 0. The predetermined distance S2 may be about 0.8 mm to about 1.5 mm. For example, when a depth of the grooves is denoted by d, the distance S2 may be about 0.8 d to about 1.5 d. The first and second groove pattern parts GP1 and GP2 may be arranged in a repeated and/or alternating fashion along the second direction.

Each of the plurality of grooves in the first and second groove portions GP1 and GP2 may have a shape corresponding to a protrusion shape of the protrusion part, e.g., the shape of the protrusion illustrated in FIG. 1, 2, or 3. For example, the groove may have a conical or pyramid shape with a vertex pointing downward. The plurality of grooves in the first groove portion GP1 may have different vertex angles but the same depth as those of the plurality of grooves in the second groove portion GP2.

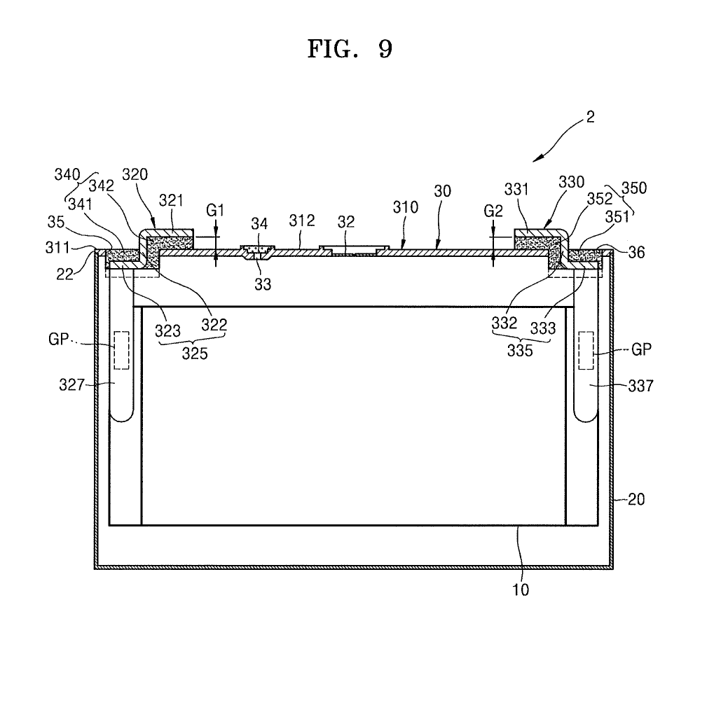

FIG. 9 illustrates a schematic cross-sectional view of a secondary battery 2 according to another example embodiment.

In the secondary battery 2 according to the present example embodiment, fixing members 340 and 350 are formed in terminal insertion holes 35 and 36, respectively, and gaps G1 and G2 between either terminal plate 321 or 331 and a top surface of a cap plate 310, respectively. According to the present example embodiment, the fixing member 340 includes a first fixing portion 341 for filling the terminal insertion hole 35 and a second fixing portion 342 for filling the gap G1 between the terminal plate 321 and the top surface 312 of the cap plate 31. Likewise, the other fixing member 350 includes a first fixing portion 351 for filling the terminal insertion hole 36 and a second fixing portion 352 for filling the gap G2 between the terminal plate 331 and the top surface 312 of the cap plate 310.

Like in the previous embodiment, the fixing members 340 and 350 may be formed using an insert injection molding process. This may improve the coupling strength between either of the terminal plates 320 and 330 and the cap plate 310. Thus, the second fixing portions 342 and 352 may increase contact areas between the terminal plate 320 and the cap plate 310 and the fixing member 340, and between the terminal plate 330 and the cap plate 310 and the fixing member 350, which may enhance the coupling strength between the terminal plates 320 and 330 and the cap plate 310. Furthermore, the terminal plates 320 and 330 are secured to the cap plate 310 by the second fixing portions 342 and 352, respectively, which may reduce the possibility that the fixing members 340 and 350 escape from the terminal insertion holes 35 and 36, respectively, during coupling between the terminal plates 320 and 330 and the cap plate 310.

The secondary batteries 1 and 2 according to the embodiments are configured so that the terminals 320 and 330 are fixed by the fixing members 340 and 350 formed by a plastic mold, but the present example embodiment is not limited thereto.

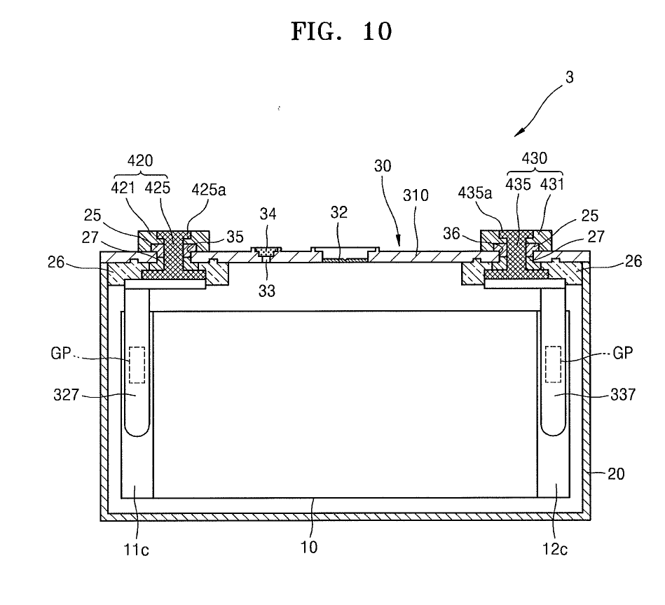

FIG. 10 illustrates a schematic cross-sectional view of a secondary battery 3 according to another example embodiment.

The difference from the previous example embodiments is that anode and cathode terminals 420 and 430 are fixed by a gasket.

According to the present example embodiment, an anode tab 327 is electrically connected to the anode terminal 420. The anode terminal 420 includes an anode terminal plate 421 and an anode connecting portion 425 for connecting the anode tab 327 with the anode terminal plate 421. The anode connecting portion 425 passes out through a terminal insertion hole 35 so as to project upward from the cap plate 310 by a predetermined length.

A cathode tab 337 is electrically connected to the cathode terminal 430. The cathode terminal 430 includes a cathode terminal plate 431 and a cathode connecting portion 435 for connecting the cathode tab 337 with the cathode terminal plate 431. The cathode connecting portion 435 passes out through a terminal insertion hole 36 so as to project upward from the cap plate 310 by a predetermined length.

The anode terminal 420 and the cathode terminal 430 are electrically insulated from and combined with the cap plate 310. For this purpose, upper and lower insulating gaskets 25 and 27 are interposed between the anode terminal 420 and the cap plate 310 and between the cathode terminal 430 and the cap plate 310, respectively, so as to electrically insulate the anode and cathode terminals 420 and 430 from the cap plate 310. For example, the upper and lower insulating gaskets 25 and 27 may be adapted to be inserted into the terminal insertion holes 35 and 36 from top and bottom surfaces of the cap plate 310, respectively. An insulating seal 26 is additionally provided to insulate the anode and cathode connecting portions 425 and 435 from the cap plate 310 or a case 20.

The anode and cathode terminal plates 421 and 431 and the anode and cathode connecting portions 425 and 435, respectively form a rivet combination. For example, front edges 425a and 435a of the anode and cathode connecting portions 425 and 435 inserted into the anode and cathode terminal plates 421 and 431 may be rivet-processed so that the front edges 425a and 435a can be spread widely and pressure welded to the anode and cathode terminal plates 421 and 431. The anode and cathode terminal plates 421 and 431 may be pressure welded to the rivet-processed front edges 425a and 435a of the anode and cathode connecting portions 425 and 435 so that the anode and cathode terminal plates 421 and 431 are firmly combined to the anode and cathode connecting portions 425 and 435. In another implementation, the anode and cathode terminal plates 421 and 431 may be coupled to the anode and cathode connecting portions 425 and 435, respectively, by another method.

By way of summation and review, a secondary battery may include an electrode assembly having anode and cathode plates and a separator, a case that accommodates the electrode assembly, a cap plate that closes the case, and a terminal portion that electrically exposes the electrode assembly out of the case. The electrode assembly may be connected to the terminal portion by ultrasonic welding.

As described above, an ultrasonic welding technique may use a small amount of energy and a short welding time, and may enable welding between heterogeneous materials. According to example embodiments, an ultrasonic horn is configured so that a plurality of protrusions are consecutively arranged on a pressing surface in one direction. The protrusions may be arranged without any space therebetween in the one direction and at intervals in another direction. The ultrasonic horn according to example embodiments may provide an efficient distribution of a tensile strength. The ultrasonic horn may be used in assembling secondary batteries and may provide excellent welding performance. A secondary battery having a high quality welding between electrode tabs and an electrode assembly, and a small electrical resistance may be provided.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. An ultrasonic horn having a pressing surface at an end thereof, the ultrasonic horn comprising:
a protrusion part disposed on the pressing surface, the protrusion part including:
a first protrusion row that includes a plurality of protrusions consecutively arranged along a first direction, and
a second protrusion row that includes a plurality of protrusions consecutively arranged along the first direction and is separated from the first protrusion row by a predetermined distance in a second direction that is different from the first direction.

2. The ultrasonic horn as claimed in claim 1, wherein the plurality of protrusions in the first and second protrusion rows have a conical or pyramid shape.

3. The ultrasonic horn as claimed in claim 2, wherein the plurality of protrusions in the first protrusion row have a different vertex angle from the plurality of protrusions in the second protrusion row.

4. The ultrasonic horn as claimed in claim 3, wherein the plurality of protrusions in the first protrusion row have a same height as that of the plurality of protrusions in the second protrusion row.

5. The ultrasonic horn as claimed in claim 1, wherein the predetermined distance is about 0.8 mm to about 1.5 mm.

6. The ultrasonic horn as claimed in claim 1, wherein the predetermined distance is about 0.8 h to about 1.5 h, where h is a height of the plurality of protrusions.

7. The ultrasonic horn as claimed in claim 1, wherein the first and second protrusion rows are repeatedly arranged along the second direction.

8. A secondary battery comprising electrode tabs and an electrode assembly ultrasonically welded to each other by using the ultrasonic horn as claimed in claim 1.

9. A secondary battery, comprising:
an electrode assembly;
an electrode tab ultrasonically welded to the electrode assembly and having a groove pattern part on one surface; and
a case accommodating the electrode assembly and the electrode tab,
wherein the groove pattern part includes a first groove portion and a second groove portion, each groove portion including a plurality of grooves arranged along a first direction, wherein the second groove portion is separated from the first groove portion by a predetermined distance in a second direction that is different from the first direction, and an interval between adjacent grooves of the plurality of grooves in the first and second groove portions is less than the predetermined distance.

10. The secondary battery as claimed in claim 9, wherein the plurality of grooves in the first and second groove portions have a conical or pyramid shape with a vertex pointing downward.

11. The secondary battery as claimed in claim 10, wherein the plurality of grooves in the first groove portion have a different vertex angle than that of the plurality of grooves in the second groove portion.

12. The secondary battery as claimed in claim 11, wherein the plurality of grooves in the first groove portion have a same depth as that of the plurality of grooves in the second groove portion.

13. The secondary battery as claimed in claim 9, wherein the predetermined distance is about 0.8 mm to about 1.5 mm.

14. The secondary battery as claimed in claim 9, wherein the predetermined distance is about 0.8 d to about 1.5 d, where d is a depth of the plurality of grooves.

15. The secondary battery as claimed in claim 9, wherein the first and second groove portions are repeatedly arranged along the second direction.

16. The secondary battery as claimed in claim 9, further comprising:
a cap plate that closes the case and has a terminal insertion hole longitudinally penetrating the cap plate;
a terminal including a terminal plate exposed out of the case and a connecting portion that passes through the terminal insertion hole and connects the electrode tab with the terminal plate; and
a fixing member that fixes the terminal to the cap plate.

17. The secondary battery as claimed in claim 16, wherein the fixing member has a plastic mold structure formed by injection molding a plastic resin into the terminal insertion hole when the connecting portion is inserted into the terminal insertion hole.

18. The secondary battery as claimed in claim 17, wherein the fixing member includes a first fixing portion for filling the terminal insertion hole and a second fixing portion for filling a gap between the terminal plate and a top surface of the cap plate.

19. The secondary battery as claimed in claim 17, wherein the fixing member includes an insulating gasket interposed between the connecting portion and the cap plate so as to fill a gap between the connecting portion and the terminal insertion hole.

20. The secondary battery as claimed in claim 19, wherein the insulating gasket includes an upper gasket adapted to be inserted into the terminal insertion hole from a top surface of the cap plate and a lower gasket adapted to be inserted into the terminal insertion hole from a bottom surface of the cap plate.
